(19) United States
(12) Patent Application Publication
(10) Pub. No.: US 2020/0389700 A1
(43) Pub. Date: Dec. 10, 2020

(54) INFORMATION PROCESSING APPARATUS AND METHOD, AND PROGRAM

(71) Applicant: SONY CORPORATION, Tokyo (JP)

(72) Inventors: Akihisa KANEKO, Tokyo (JP); Fuminori HOMMA, Tokyo (JP)

(73) Assignee: Sony Corporation, Tokyo (JP)

(21) Appl. No.: 16/641,324

(22) PCT Filed: Aug. 21, 2018
(86) PCT No.: PCT/JP2018/030727

§ 371 Date: Feb. 24, 2020

(30) Foreign Application Priority Data
Sep. 4, 2017 (JP) 2017-169432

(51) Int. Cl. H04N 21/442; H04N 21/81; H04N 21/431

(52) U.S. Cl. CPC H04N 21/44218; H04N 9/31; H04N 21/4316; H04N 21/8133

(57) ABSTRACT

The present technique relates to an information processing apparatus and method, and a program that enable presentation of objects of interest to a user through natural interactions with the user. The information processing apparatus detects a matter of interest of a user from information such as a line of sight of the user, a posture of the user, or utterance details of the user during reproduction of main content projected onto a screen. The information processing apparatus controls output of sub-content and an utterance sound regarding the sub-content on the basis of the matter of interest of the user. The present technique can be applied to a content reproduction system.

### TECHNICAL FIELD

The present technique relates to an information processing apparatus and method, and a program, and in particular relates to an information processing apparatus and method, and a program that enable presentation of objects of interest to a user through natural interactions with the user.

### BACKGROUND ART

Techniques of projecting images onto a predetermined work plane, and performing interactions with user gestures have been proposed (see PTL 1).

### CITATION LIST

### Patent Literature

### [PTL 1]

WO 2014/073345

### SUMMARY

### Technical Problem

However, the proposal in PTL 1 requires a user to perform particular predetermined gestures, and more improved interactions have been demanded.

The present technique has been made in view of such a circumstance, and makes it possible to present objects of interest to a user with natural interactions with the user.

### Solution to Problem

An information processing apparatus according to one aspect of the present technique includes an interest detecting unit detecting a matter of interest of a user regarding main content during reproduction of the main content, and an output control unit controlling output of sub-content and an utterance sound regarding the sub-content on the basis of the matter of interest of the user.

In one aspect of the present technique, a matter of interest of a user regarding main content is detected during reproduction of the main content, and output of sub-content, and an utterance sound regarding the sub-content on the basis of the matter of interest of the user is controlled.

### Advantageous Effect of Invention

According to the present technique, it is possible to present objects of interest to a user through natural interaction with the user.

Note that effects are not necessarily limited to the ones described here, and may be any of the effects described in the present disclosure.

### BRIEF DESCRIPTION OF DRAWINGS

FIG. 1 is a figure illustrating an example of a content reproduction system according to one embodiment of the present technique.

FIG. 2 is a block diagram illustrating a configuration example of the content reproduction system in FIG. 1.

FIG. 3 is a block diagram illustrating a hardware configuration example of an arithmetic operation apparatus.

FIG. 4 is a block diagram illustrating a functional configuration example of the arithmetic operation apparatus.

FIG. 5 is a figure for explaining matter-of-interest detection and degree-of-interest determination.

FIG. 6 is a figure for explaining the transition in a switch of sub-content.

FIG. 7 is a figure for explaining transition of a switch of sub-content following the switch in FIG. 6.

FIG. 8 is a figure for explaining the transition of a switch of sub-content following the switch in FIG. 7.

FIG. 9 is a figure for explaining output positions of main content and sub-content.

FIG. 10 is a flowchart for explaining a content reproduction process of the content reproduction system.

FIG. 11 is a flowchart for explaining the content reproduction process of the content reproduction system continued from FIG. 10.

### DESCRIPTION OF EMBODIMENTS

Hereinafter, modes for carrying out the present technique are explained. The explanations are given in the following order.

1. Configuration Example of Content Reproduction System

2. Configuration Example of Arithmetic Operation Apparatus

3. Switch Example of Sub-Content

4. Operation Example of Content Reproduction System

5. Modification Examples

6. Other Examples

### 1. Configuration Example of Content Reproduction System

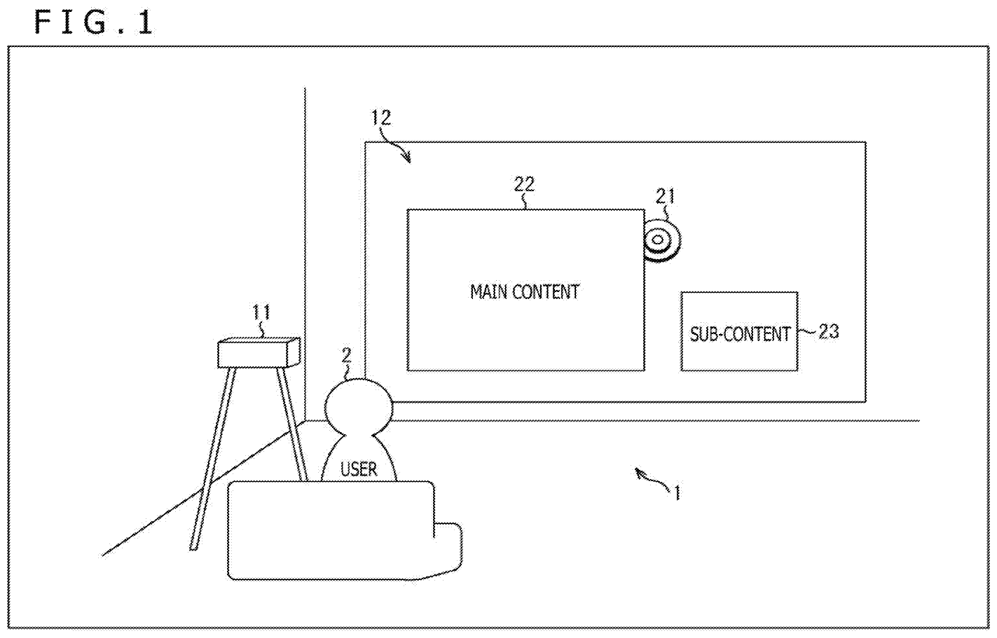

FIG. 1 is a figure illustrating an example of a content reproduction system according to one embodiment of the present technique.

A content reproduction system 1 in FIG. 1 includes a screen 12 installed on a wall surface of a room or the like, and a projector 11 that projects various types of information such as content onto the screen 12. It is assumed in the example in FIG. 1 that a couch is placed facing the screen 12, and a user 2 is seated on the couch. The projector 11 is placed near the user 2.

Content such as television programs or videos distributed by video distribution sites are projected by the projector 11. Along with projection of images of content, sounds of the content are output from a speaker not illustrated. The user can specify preferred content, and view and listen to the specified content.

Projection by the projector 11 is performed according to control by an arithmetic operation apparatus (not illustrated in FIG. 1) that is connected with the projector 11 via wired or wireless communication. The arithmetic operation apparatus may be provided in the room where the projector 11 and the like are provided or may be provided in another room. It may be configured such that functions of the arithmetic operation apparatus are implemented in the projector 11.

Viewing and listening of content in the content reproduction system 1 having such configuration are proceeded through interactions by utterances from and to an agent, for example. That is, in addition to the content reproduction function, the arithmetic operation apparatus has an agent function of analyzing details of utterance sounds of the user 2, and performing predetermined sound responses to the utterance sounds. In the example of FIG. 1, an agent UI 21 which is an image representing an agent is projected in order for the user 2 to be able to visually recognize the agent function.

Although the agent UI 21 is an image of concentric circles in the example of FIG. 1, it may be an image of another shape or an image such as a human-like or animal-like character. The agent UI 21 is appropriately displayed with modified colors and shapes as appropriate while interacting with the user 2.

The user 2 can talk to the agent, for example, to specify content he/she wishes to view and listen to, and request detailed information regarding details of the content while viewing and listening to the content.

Specific examples of display are mentioned below, and the agent presents images related to a matter of interest of the user 2 (e.g., a still image or video content) as sub-content 23 while content that the user 2 desires (e.g., a still image or video content) is reproduced as main content 22 as illustrated in FIG. 1. The matter of interest of the user 2 is a matter that the user 2 is interested in or a matter that the user 2 has an interest in. Presentation of the sub-content 23 is not only performed according to an explicit instruction from the user 2, for example, but also performed automatically without instructions from the user 2 as appropriate. Images displayed as the sub-content 23 may be a video distributed by a video distribution site or may be a still image such as a screen of a Web page.

In addition, the agent outputs a sound for commenting on details of the sub-content 23, along with projection of the sub-content 23. Hereinafter, the sound for commenting on details of the sub-content 23 is called a commentary sound, as appropriate. The commentary sound is generated by performing sound synthesis on the basis of information regarding the sub-content 23 which is acquired from a Web page or the like, for example.

The matter of interest of the user 2 is detected not only by analyzing utterance details of the user 2, but also by detecting a line of sight or a posture of the user 2 viewing and listening to the main content 22. The content reproduction system 1 is also provided with a component such as a camera used for detection of the line of sight or posture of the user 2.

In this manner, by using the content reproduction system 1, it is possible for the user 2 to view and listen to content as if he/she is viewing and listening to the content together with the agent while having a conversation with the agent. In addition, the user 2 can easily check information related to the matter of interest of the user 2.

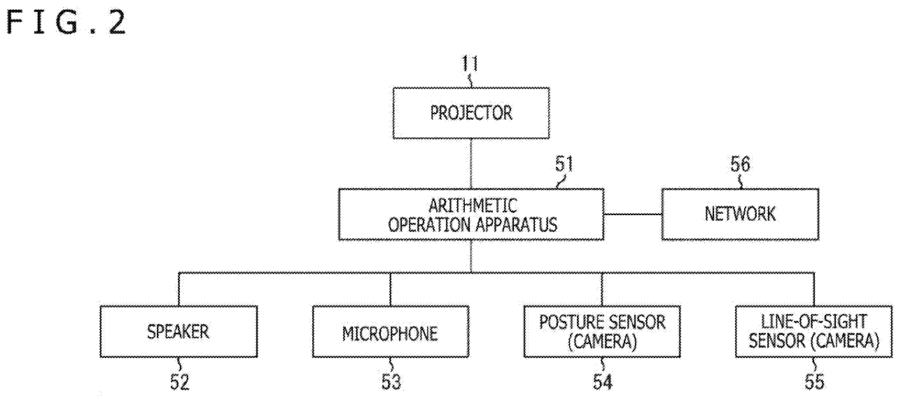

FIG. 2 is a block diagram illustrating a configuration example of the content reproduction system 1.

In addition to the projector 11, the content reproduction system 1 includes an arithmetic operation apparatus 51, a speaker 52, a microphone 53, a posture sensor 54, and a line-of-sight sensor 55. Each component is connected to each other via wired or wireless communication. The arithmetic operation apparatus 51 is connected to a network 56 such as the internet.

The arithmetic operation apparatus 51 reproduces main content that a user desires, outputs an image of the main content to the projector 11, and outputs sounds of the main content to the speaker 52.

The arithmetic operation apparatus 51 uses the functions of the agent mentioned above to detect a change in a state of the user during reproduction of the main content on the basis of information input through the microphone 53, the posture sensor 54, the line-of-sight sensor 55, and the like.

That is, the arithmetic operation apparatus 51 analyzes sounds input through the microphone 53 during reproduction of the main content to thereby detect an utterance sound of the user, analyze details of the utterance sound of the user, and detect a change in the state of the user on the basis of results of the analysis. In addition, the arithmetic operation apparatus 51 analyzes images captured by a camera included in the posture sensor 54 to thereby estimate the posture of the user, and detect a change in the state of the user on the basis of the estimated posture. The arithmetic operation apparatus 51 analyzes images captured by a camera included in the line-of-sight sensor 55 to thereby estimate a direction of the line of sight of the user, and detect a change in the state of the user on the basis of the estimated direction of the line of sight.

In a case in which there may be a change in the state of the user, there is a change in the degree of interest which is an extent of interest of the user in a matter of interest, in many cases. Accordingly, the arithmetic operation apparatus 51 detects a matter of interest from the detected change in the state of the user, and determines the degree of interest in the matter of interest. The arithmetic operation apparatus 51 acquires, via the network 56, for example, sub-content corresponding to the matter of interest, and information regarding the sub-content from which a commentary sound is made. The arithmetic operation apparatus 51 outputs images of the sub-content to the projector 11 for projection, and outputs the sound of the sub-content, and the commentary sound to the speaker 52.

The speaker 52 outputs the sound supplied from the arithmetic operation apparatus 51. The sounds of the main content, the sound of the sub-content, the commentary sound, and the like are output from the speaker 52.

The microphone 53 detects an utterance sound of the user and outputs to the arithmetic operation apparatus 51.

The posture sensor 54 includes a sensor such as a camera. The posture sensor 54 captures images of a user who is viewing and listening to main content, and inputs images obtained by the capturing to the arithmetic operation apparatus 51.

The line-of-sight sensor 55 include a camera or the like, captures images of the user, detects the line of sight of the user from the captured images, and inputs information regarding the detected line of sight of the user to the arithmetic operation apparatus 51.

### 2. Configuration Example of Arithmetic Operation Apparatus

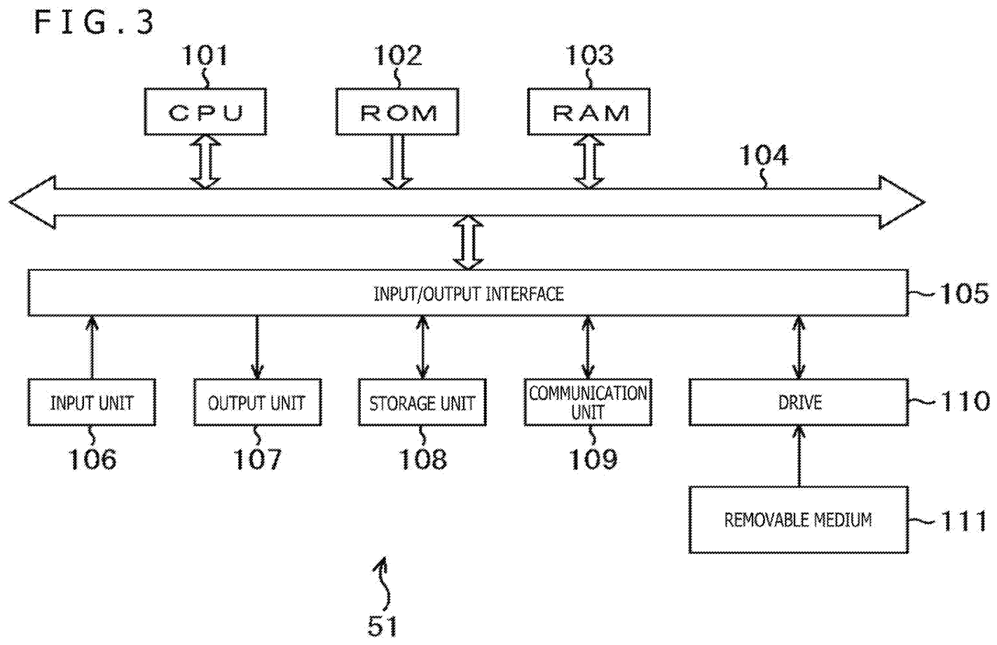

FIG. 3 is a block diagram illustrating a hardware configuration example of the arithmetic operation apparatus 51.

A CPU 101, a ROM 102, and a RAM 103 are interconnected by a bus 104. An input/output interface 105 is further connected to the bus 104.

An input unit 106 and an output unit 107 are connected to the input/output interface 105. The input unit 106 receives input of information from the microphone 53, the posture sensor 54, and the line-of-sight sensor 55 in FIG. 2. The input unit 106 may include a keyboard, a mouse, and the like. The output unit 107 outputs images to the projector 11 in FIG. 1, and outputs sounds to the speaker 52 in FIG. 2. In addition, a storage unit 108, a communication unit 109, and a drive 110 are connected to the input/output interface 105.

The storage unit 108 include a hard disk, a non-volatile memory, or the like.

The communication unit 109 includes a network interface, is connected to the network 56 via wireless or wired communication, and performs communication with a server not illustrated, and the like.

The drive 110 drives a removable medium 111, and reads out data stored in the removable medium 111 or writes data in the removable medium 111.

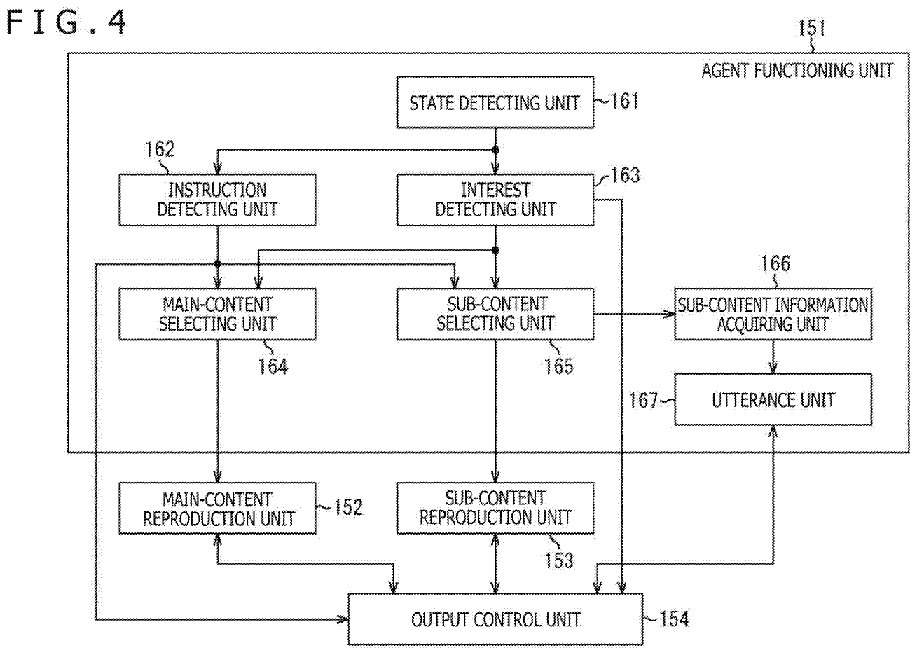

FIG. 4 is a block diagram illustrating a functional configuration example of the arithmetic operation apparatus 51. At least some of functioning units illustrated in FIG. 4 are realized by a predetermined program being executed by the CPU 101 in FIG. 3.

As illustrated in FIG. 4, an agent functioning unit 151, a main-content reproduction unit 152, a sub-content reproduction unit 153, and an output control unit 154 are realized in the arithmetic operation apparatus 51.

The agent functioning unit 151 functions as the agent mentioned above. The agent functioning unit 151 includes a state detecting unit 161, an instruction detecting unit 162, an interest detecting unit 163, a main-content selecting unit 164, a sub-content selecting unit 165, a sub-content information acquiring unit 166, and an utterance unit 167. Utterance sounds of a user from the microphone 53, images captured by the posture sensor 54, and images captured by the line-of-sight sensor 55 are input to the state detecting unit 161.

The state detecting unit 161 analyzes the utterance sounds of the user from the microphone 53, and identifies utterance details of the user. The state detecting unit 161 analyzes the images captured by the posture sensor 54 to thereby identify the posture of the user. The state detecting unit 161 analyzes the images captured by the line-of-sight sensor 55 to thereby identify the direction of the line of sight of the user. The state detecting unit 161 detects a change in the state of the user from at least one of the identified utterance details of the user, the identified posture of the user, and the identified direction of the line of sight of the user.

For example, in a case in which the line of sight of the user is directed to a certain area of content for a predetermined length of time, in a case in which the user takes a posture of leaning forward, in a case in which the user takes a posture of pointing a finger, in a case in which the user gives utterance regarding details of content being reproduced, or in other similar cases, a change in the state of the user, that is, a change in the degree of interest of the user in a matter of interest is detected.

Postural information representing the identified posture of the user, and line-of-sight information representing the identified direction of the line of sight of the user are input to the instruction detecting unit 162 and the interest detecting unit 163.

The instruction detecting unit 162 detects an explicit instruction from the user on the basis of the utterance sound, the postural information, or the line-of-sight information of the user. Such an explicit instruction means a direct instruction of content such as an utterance sound, “I want to watch this content” or information regarding a posture of pointing a finger at an object in main content that the user wants to watch. It may be configured such that the instruction of the user is input by use of the keyboard, the mouse, or the like of the input unit 106. The instruction detecting unit 162 supplies instruction information representing details of the instruction of the user to the main-content selecting unit 164, the sub-content selecting unit 165, and the output control unit 154.

On the basis of at least one type of information among the utterance sound, the postural information, and the line-of-sight information of the user, the interest detecting unit 163 detects a matter of interest of the user, and determines the presence or absence of interest or degree of interest in the matter of interest. The degree of interest may be calculated and determined, and in addition, the presence or absence of the degree of interest may be determined by decision. In the interest detecting unit 163, not only the matter of interest, but also the degree of interest in overall main content and sub-content may be determined.

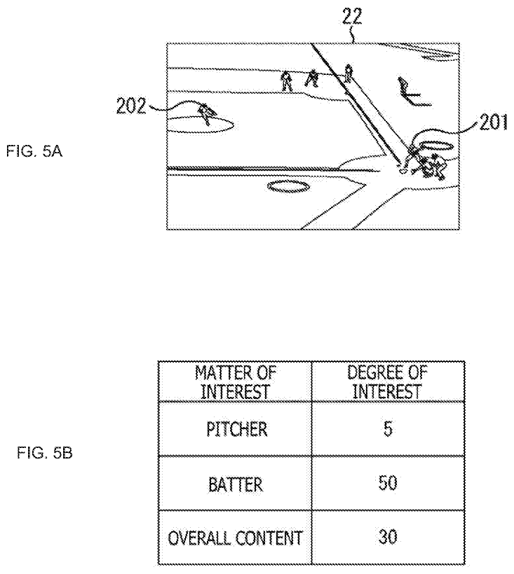

FIG. 5 is a figure for explaining matter-of-interest detection, and degree-of-interest determination by the interest detecting unit 163.

A user is viewing and listening to a video of a baseball game as the main content 22. As illustrated in A in FIG. 5, a batter 201 is displayed on the right side in the main content 22, and a pitcher 202 is displayed on the left side thereof. At this time, when the line of sight of the user detected from images of the line-of-sight sensor 55 is directed to the right side, it can be known that the interest in the batter 201 is higher than the interest of the user in the pitcher 202. In this case, it is detected that the batter 201 is a matter of interest, and a degree of the interest therein is determined.

In a case in which the line of sight of the user moves to the left side sometimes, it can be known that the user is less interested in the pitcher 202 than in the batter 201, but is interested in the pitcher 202. it is detected that the pitcher 202 is also a matter of interest, and a degree of the interest therein is determined.

In addition to information regarding the line of sight, for example, in a case in which utterance of the user includes a phrase mentioning the batter like, “this batter is . . . ,” the degree of interest in the batter 201 increases further. Furthermore, in a case in which it is detected that the user is taking a posture of leaning toward the right side of the main content 22, the degree of interest in the batter 201 increases further.

The degree of interest in the main content 22 is determined from how long the user is gazing at the main content 22, whether the user is having a chat which is not related to the main content 22, or other factors.

As mentioned above, on the basis of at least one of the line of sight, the utterance details, and the posture of the user, matters of interest of the user such as the batter 201, the pitcher 202, the overall main content 22 are detected, and the degree of interest in each of the matters of interest is determined as illustrated in B in FIG. 5. Note that although the examples mentioned here as the matters of interest are content that can be visually recognized, the interest detecting unit 163 may detect, as the matter of interest of the user, audio content such as background music of the main content, and determine a degree of interest therein.

In the example illustrated in B in FIG. 5, in the order from the top of the table, the degree of interest in “Pitcher 202” as a matter of interest is “5,” the degree of interest in “Batter 201” as a matter of interest is “50,” and the degree of interest in the overall content as a matter of interest is “30.”

By referring to these matters of interest and degrees of interest, the sub-content selecting unit 165 can select sub-content.

In a case in which the degree of interest of a user in a matter of interest is higher than a predetermined threshold, the interest detecting unit 163 supplies information regarding the matter of interest to the sub-content selecting unit 165. In a case in which there are a plurality of matters of interest, information regarding the matter of interest with the highest degree of interest is supplied to the sub-content selecting unit 165.

In addition, the interest detecting unit 163 supplies information regarding the determined degrees of interest to the output control unit 154. The supplied information regarding the degrees of interest is used in control of output of content, commentary sounds, and the like.

On the basis of user instruction information from the instruction detecting unit 162, the main-content selecting unit 164 selects main content to be reproduced, acquires the selected main content, and supplies the acquired main content to the main-content reproduction unit 152. Information regarding the URL of the main content may be acquired instead of the main content itself.

On the basis of matters of interest from the interest detecting unit 163, the sub-content selecting unit 165 controls the communication unit 109, and selects sub-content from a server not illustrated, or the like, via the network 56. The selected sub-content is supplied to the sub-content reproduction unit 153, and sub-content information acquiring unit 166. Also in the case of the sub-content, information regarding the URL of the sub-content may be acquired instead of the sub-content itself.

On the basis of the sub-content selected by the sub-content selecting unit 165, the sub-content information acquiring unit 166 acquires information regarding the sub-content from a server not illustrated, or the like. The sub-content information acquiring unit 166 supplies the acquired information regarding the sub-content to the utterance unit 167.

On the basis of the information regarding the sub-content acquired by the sub-content information acquiring unit 166, the utterance unit 167 performs sound synthesis, and generates data of a commentary sound. The utterance unit 167 supplies the generated data of the commentary sound to the output control unit 154.

The main-content reproduction unit 152 reproduces the main content supplied from the main-content selecting unit 164, and outputs the main content reproduced to the output control unit 154.

The sub-content reproduction unit 153 reproduces the sub-content supplied from the sub-content selecting unit 165, and outputs the sub-content reproduced to the output control unit 154.

The output control unit 154 controls output of the main content reproduced by the main-content reproduction unit 152, and the sub-content reproduced by the sub-content reproduction unit 153. In addition, the output control unit 154 controls output of a commentary sound. Display of the agent UI 21 representing the agent is also controlled by the output control unit 154.

### 3. Switch Example of Sub-Content

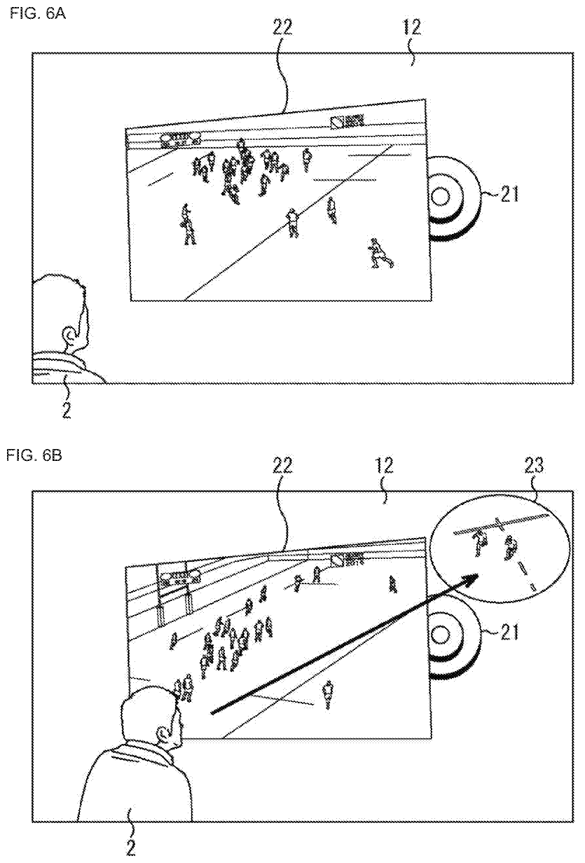

Next, the transition of a switch of sub-content is explained with reference to FIGS. 6 to 8.

A in FIG. 6 is a figure illustrating an example of the state where the user 2 is viewing and listening to the main content 22 being reproduced. The main content 22 and the agent UI 21 arranged on the right side of the main content 22 are displayed on the screen 12 in A in FIG. 6.

It is assumed that such a user 2 who is watching a video of such a rugby game as the main content 22 talks to the agent, “Rugby players can run fast.”

In this case, the state detecting unit 161 detects, as a change in the state of the user, the utterance details of the user 2, “Rugby players can run fast.” The interest detecting unit 163 detects a matter of interest “rugby players who can run fast,” and determines a degree of interest in the matter of interest “rugby players who can run fast.” The sub-content selecting unit 165 selects the sub-content 23 on the basis of the matter of interest “rugby players who can run fast,” and the sub-content reproduction unit 153 reproduces the selected sub-content 23.

On the basis of the matter of interest “rugby players who can run fast,” the sub-content information acquiring unit 166 acquires information regarding sub-content from which a commentary sound is made. On the basis of the information regarding the sub-content, the utterance unit 167 performs sound synthesis, and generates data of a commentary sound, “For your information, a video of Marine Halls, who is the world's fastest rugby player, is this.”

The output control unit 154 causes the sub-content 23 regarding “rugby players who can run fast” to be projected on the screen 12 as illustrated in B in FIG. 6, and causes the speaker 52 to output the commentary sound, “For your information, a video of Marine Halls, who is the world's fastest rugby player, is this.”

Since sub-content is selected on the basis of a matter of interest, the degree of interest in the matter of interest can be said to be the degree of interest in the sub-content. The image projection of the sub-content 23 and the commentary sound continue until the degree of interest of the user 2 in the sub-content 23 becomes lower than a preset threshold.

It is assumed that, in a state where such presentation of the sub-content 23 is being performed, the user 2 talks to the agent, “Wow, he runs really fast!” while leaning forward, and watching the sub-content 23 as indicated by an arrow in B in FIG. 6.

In this case, the state detecting unit 161 detects the utterance details of the user 2, “Wow, he runs really fast!” and the his/her posture of leaning forward as a change in the state of the user. On the basis of the last commentary sound, “For your information, a video of Marine Halls, who is the world's fastest rugby player, is this,” and the utterance details, “Wow, he runs really fast!” and the posture of leaning forward at this time, the interest detecting unit 163 detects a matter of interest “Marine Halls,” and determines a degree of interest in the matter of interest “Marine Halls.”

Since the determined degree of interest of the user in the matter of interest (i.e., sub-content) is not lower than a predetermined threshold, the sub-content selecting unit 165 selects the sub-content 23 on the basis of the matter of interest “Marine Halls,” and the sub-content reproduction unit 153 reproduces the selected sub-content 23.

On the basis of the matter of interest “Marine Halls,” the sub-content information acquiring unit 166 acquires information regarding sub-content from which a commentary sound is made. On the basis of the information regarding the sub-content, the utterance unit 167 performs sound synthesis, and generates data of a commentary sound “His best time for the 100 metres is surprisingly 10.13 seconds. He runs very fast at such a sufficient level that he is qualified for participation even in the Olympics.”

The output control unit 154 causes the sub-content 23 regarding “Marine Halls” to be projected on the screen 12 as illustrated in B in FIG. 6, and outputs the commentary sound, “His best time for the 100 metres is surprisingly 10.13 seconds. He runs very fast at such a sufficient level that he is qualified for participation even in the Olympics.”

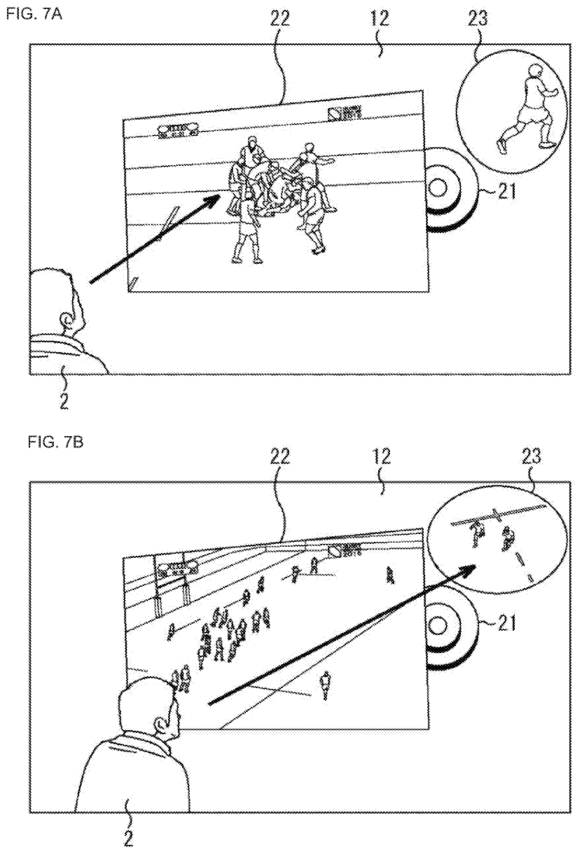

It is assumed that the user 2 keeps watching the sub-content 23 quietly as illustrated in A in FIG. 7.

In this case, the state detecting unit 161 detects a posture in which the user 2 keeps watching the sub-content 23 quietly as a change in the state of the user 2. On the basis of the last commentary sound, the commentary sound before the last commentary sound, and the posture of keeping watching the sub-content 23 quietly, the interest detecting unit 163 detects a matter of interest “Marine Halls,” and determines a degree of interest in the matter of interest “Marine Halls.”

Since the determined degree of interest of the user in the matter of interest (i.e., sub-content) is not lower than a predetermined threshold, the sub-content selecting unit 165 selects the sub-content 23 on the basis of the matter of interest “Marine Halls,” and the sub-content reproduction unit 153 reproduces the selected sub-content 23.

On the basis of the matter of interest “Marine Halls,” the sub-content information acquiring unit 166 acquires information regarding sub-content from which a commentary sound is made. On the basis of the information regarding the sub-content, the utterance unit 167 performs sound synthesis, and generates data of a commentary sound, “Marine Halls was a track and field sprinter before, and . . . .”

The output control unit 154 causes the sub-content 23 regarding “Marine Halls” to be projected on the screen 12 as illustrated in B in FIG. 6, and causes the speaker 52 to output the commentary sound, “Marine Halls was a track and field sprinter before, and . . . .”

It is assumed that, although the sub-content 23 is projected, the user 2 changes the direction of the line of sight to watch the main content 22 as indicated by an arrow in B in FIG. 7.

In this case, the state detecting unit 161 detects the line of sight of the user 2 which has been changed for watching the main content 22 as a change in the state of the user. On the basis of the last commentary sound and the line of sight of the user 2 which has been changed for watching the main content 22, the interest detecting unit 163 detects a matter of interest “Marine Halls,” and determines a degree of interest in the matter of interest “Marine Halls.”

Since the determined degree of interest of the user in the matter of interest (i.e., sub-content) became lower than a predetermined threshold, the output control unit 154 stops output of the image projection of the sub-content 23 and the commentary sound as illustrated in FIG. 8 after an elapse of a certain length of time.

As mentioned above, on the basis of the degree of interest of the user in a matter of interest, the sub-content 23 and the information regarding the sub-content as a commentary sound are output as a commentary sound.

Accordingly, it is possible to present objects of interest to a user through natural interactions with the user. Highly convenient and entertaining viewing and listening are provided for the user.

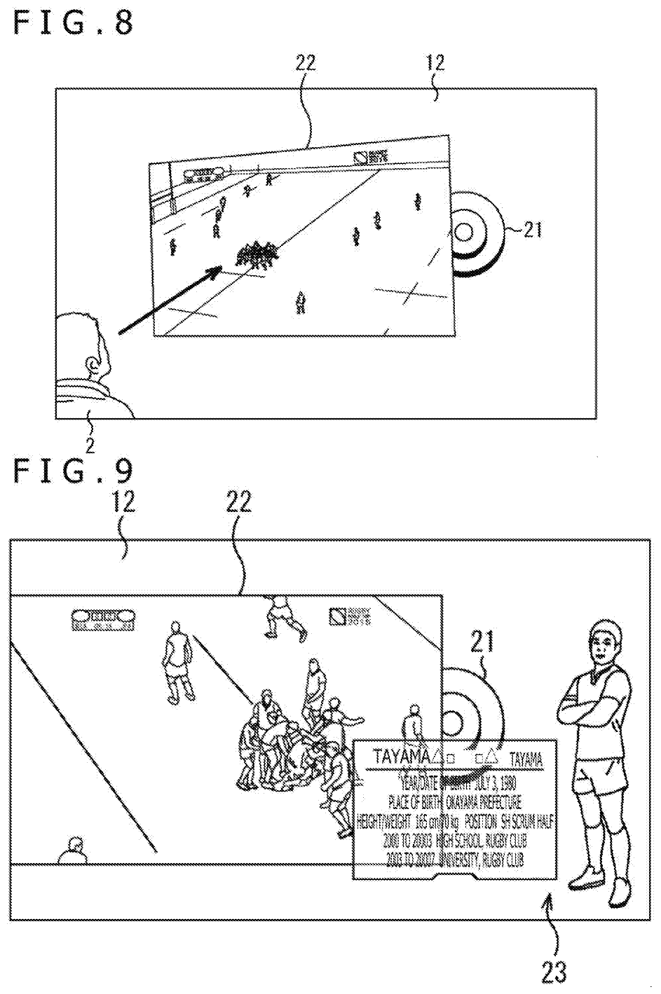

FIG. 9 is a figure for explaining an output position of the main content 22, and an output position of the sub-content 23.

As illustrated in FIGS. 6 to 8, the output control unit 154 causes the sub-content 23 to be displayed at a position which is in a sight of the user 2 watching the main content 22 and is different from the position of the main content 22.

In contrast to this, the output control unit 154 can output the sub-content 23 at a position which partially overlaps the main content 22 and is in a sight of the user watching the main content 22 as illustrated in FIG. 9.

In this case, the output control unit 154 may be configured to output the sub-content 23 such that a transparency of part of the sub-content 23 that partially overlaps the main content 22 is modified.

### 4. Operation Example of Content Reproduction System

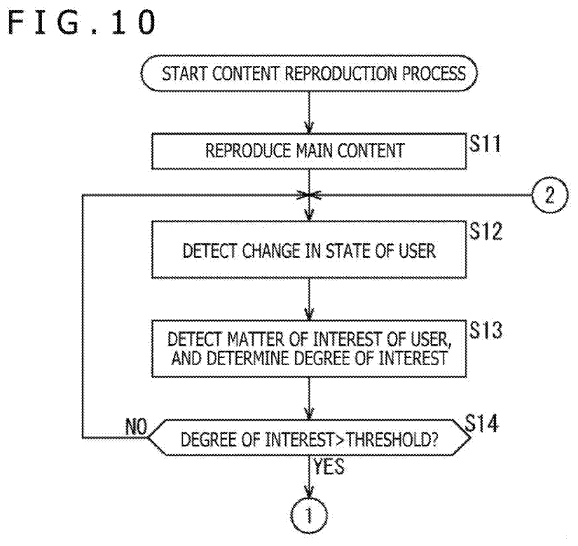

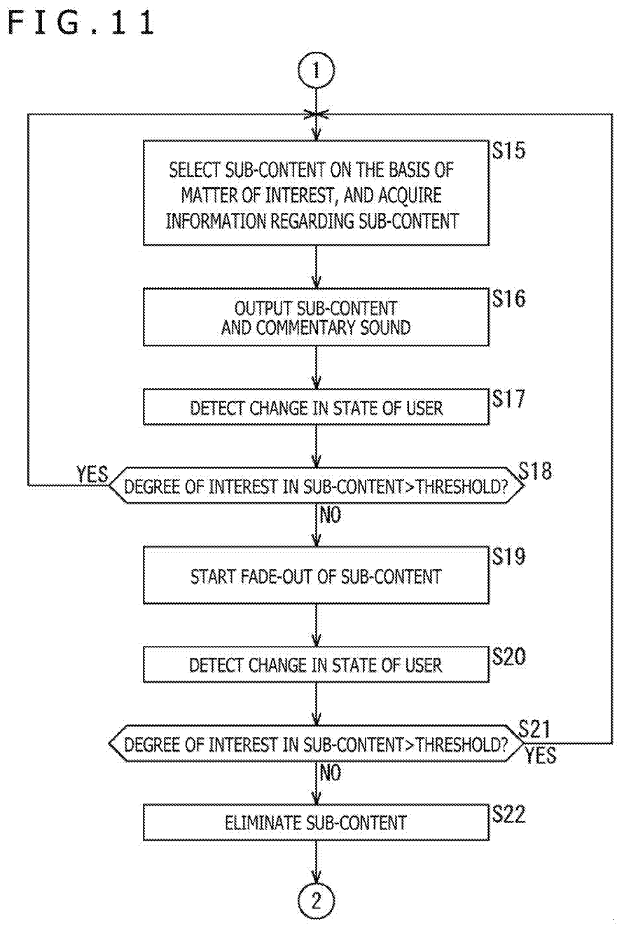

Next, a content reproduction process by the content reproduction system 1 is explained with reference to the flowcharts in FIGS. 10 and 11.

After the content reproduction system 1 is activated, an object of the agent UI 21 is output by the output control unit 154 and projected onto the screen 12. For example, the user 2 gives utterance to the agent, “I want to watch content something like XX,” to instruct reproduction of the main content 22. The agent UI 21 may be displayed simultaneously with the content reproduction system 1, and the instruction of reproduction of the main content.

At Step S11, the main content is selected according to the instruction, and reproduction of the selected main content is started. In response to the start of the reproduction of the main content, detection of the state of the user is started.

The user 2 changes the direction of the line of sight or his/her posture or gives utterance while viewing and listening to the main content 22. The microphone 53, the posture sensor 54, and the line-of-sight sensor 55 acquire information, and supply the acquired information to the state detecting unit 161.

At Step S12, the state detecting unit 161 detects a change in the state of the user from the information from the microphone 53, the posture sensor 54, and the line-of-sight sensor 55.

At Step S13, the interest detecting unit 163 detects a matter of interest of the user 2 and determines a degree of interest in the matter of interest.

At Step S14, the interest detecting unit 163 decides whether or not the degree of interest of the user 2 in the matter of interest is higher than a threshold. The threshold is preset. In a case in which it is decided at Step S14 that the degree of interest of the user 2 is lower than the threshold, the process returns to Step S12, and the processes at and after Step S12 are repeated.

In a case in which it is decided at Step S14 that the degree of interest of the user 2 is higher than the threshold, the process proceeds to Step S15 in FIG. 11. Information regarding the matter of interest of the user 2 is supplied to the sub-content selecting unit 165.

At Step S15, the sub-content selecting unit 165 selects the sub-content 23 on the basis of the matter of interest, and the sub-content information acquiring unit 166 acquires information regarding the sub-content. Information regarding the selected sub-content 23 is supplied to the sub-content reproduction unit 153, and the acquired information regarding the sub-content is supplied to the utterance unit 167.

The sub-content reproduction unit 153 reproduces the sub-content 23, and on the basis of the information regarding the sub-content 23, the utterance unit 167 performs sound synthesis and generates data of a commentary sound. The sub-content 23 reproduced, and the generated data of the commentary sound are supplied to the output control unit 154.

At Step S16, the output control unit 154 outputs the sub-content 23 reproduced and the commentary sound.

The user 2 changes the direction of the line of sight or his/her posture or gives utterance while viewing and listening to the sub-content 23 selected on the basis of the matter of interest. The microphone 53, the posture sensor 54, and the line-of-sight sensor 55 acquire information and supply the acquired information to the state detecting unit 161.

At Step S17, the state detecting unit 161 detects a change in the state of the user from the information from the microphone 53, the posture sensor 54, and the line-of-sight sensor 55.

The interest detecting unit 163 determines a degree of interest in the matter of interest, that is, the sub-content 23.

At Step S18, the output control unit 154 decides whether or not the degree of interest of the user 2 in the sub-content 23 is higher than the threshold. In a case in which it is decided at Step S18 that the degree of interest of the user 2 in the sub-content 23 is higher than the threshold, the process returns to Step S15, and the processes at and after Step S15 are repeated.

In a case in which it is decided at Step S18 that the degree of interest of the user 2 is lower than the threshold, the process proceeds to Step S19.

At Step S19, the output control unit 154 starts a fade-out of the sub-content 23.

The user 2 changes the direction of the line of sight or his/her posture or gives utterance while viewing and listening to the main content 22 or the sub-content 23. The microphone 53, the posture sensor 54, and the line-of-sight sensor 55 acquire information and supply the acquired information to the state detecting unit 161.

At Step S12, the state detecting unit 161 detects a change in the state of the user from the information from the microphone 53, the posture sensor 54, and the line-of-sight sensor 55.

The interest detecting unit 163 determines a degree of interest in the matter of interest, that is, a degree of interest in the sub-content 23.

At Step S21, the output control unit 154 decides whether or not the degree of interest of the user 2 in the sub-content 23 is higher than the threshold. In a case in which it is decided at Step S21 that the degree of interest of the user 2 in the sub-content 23 is higher than the threshold, the process returns to Step S15, and the processes at and after Step S15 are repeated. That is, the sub-content 23 and the commentary sound are reproduced again.

In a case in which it is decided at Step S21 that the degree of interest of the user 2 is lower than a predetermined threshold, the process proceeds to Step S22.

At Step S22, the output control unit 154 eliminates the sub-content 23. That is, output of the sub-content 23 and the commentary sound is stopped. Thereafter, the process returns to Step S12 in FIG. 10, and the processes at and after Step S12 are repeated. Note that the output of the sub-content 23 and commentary sound may be stopped when an explicit instruction from the user to end the output is detected from the start of the fade-out of the sub-content 23 until completion of the fade out.

Note that the degree of interest of the user 2 in the sub-content 23 may be compared not with a threshold, but with the degree of interest of the user 2 in the main content 22 at Step S18.

In a case in which the degree of interest in the main content 22 is lower than the threshold or than the degree of interest in the sub-content 23, control may be performed to cause the main content 22 to fade out. In a case in which the degree of interest in the sub-content 23 is higher than the degree of interest in the main content 22, statuses of content as main content or sub-content may be switched, setting the main content 22 as sub-content 23, and setting the sub-content 23 as main content 22.

The size of an output screen or an output position of each of the main content 22 and the sub-content 23 may be changed according to the degree of interest in the main content 22 or the sub-content 23.

In addition, although it is configured such that sub-content fades out when the degree of interest becomes low at Step S19, it may be configured such that, instead of causing the sub-content to fade out, display of alternative content is proposed or alternative content is displayed. At that time, a commentary sound of the alternative content is also output.

### 5. Modification Examples

<Display Method>

In the explanation above, a case in which both main content and sub-content are presented by projection onto a wall (the screen 12) by use of the projector 11 has been described. However, methods of presentation of content are not limited thereto.

It is possible to display main content and sub-content on display devices such as a television, a smartphone, a glasses-type display, or a smart watch. For example, it may be configured to display main content on a glasses-type display, and display sub-content on a smart watch.

In addition, it may be configured to perform presentation of content by using a combination of projection onto a wall, and display on a display device, for example, by projecting main content onto the wall, and displaying sub-content on the display device. Combinations of these presentation methods are not limited particularly.

In addition, although both main content and sub-content include images and sounds in the explanation above, content may include only images, or content may include only sounds. Although it becomes difficult to detect an interest of a user on the basis of line-of-sight information in a case in which content includes only sounds, a matter of interest of the user can be detected by detecting reactions of the user such as nods or by detecting how the user is reacting to content such as music during reproduction of the content.

<Use Case>

Although it is configured to display sub-content corresponding to an interest of a user during reproduction of main content in the explanation above, other sub-content may be additionally displayed at another position in a case in which the user has an interest in details of the sub-content during reproduction of the sub-content. For example, an image regarding display details of the sub-content is displayed as other sub-content.

In addition, although the number of users is one in the explanation above, the present technique can cope with a case where the number of users is plural. In a case in which the number of users is plural, it may be configured to determine degrees of interest in matters of interest of a plurality of users, and switch sub-content to be displayed according to types of the matters of interest, a ratio of the degrees of interest, majority decision on the degrees of interest, an average of the degrees of interest, or the like. Alternatively, it may be configured to display sub-content corresponding to the degree of interest in the matter of interest separately for each of the plurality of users.

Furthermore, although decision by use of a threshold is explained as decision of a degree of interest in the explanation above, the interest detecting unit 163 may be configured to decide whether or not a user is interested in a matter of interest by a machine learning process. At that time, other than decision for classification into two categories, i.e., whether or not the user has an interest, decision for classification into multiple categories may be performed. That is, decision of a degree of interest is decided on the basis of a predetermined reference. For example, the interest detecting unit 163 may use a neural network optimized through learning processes by using one or more of an utterance sound, postural information, and line-of-sight information of a user as input, and a matter of interest, and a degree of interest as output to perform a process of determining the matter of interest and the degree of interest.

The present technique can be applied also to a combination of the real world and sub-content. That is, it may be configured to display sub-content on a smartphone on the basis of a matter of interest while a user is watching a game (main content) that is actually in progress in front of his/her eyes at a sports stadium or the like.

Furthermore, it may be configured such that matters of interest are detected outside the user's home, information with a high degree of interest in a determined matter of interest is stored in advance, and when he/she gets home, sub-content is displayed on the basis of the matter of interest that has been stored outside the user's home.

Although an example in which a matter of interest of a user is detected and sub-content is reproduced according to the detected matter of interest of the user is described in the explanation above, it may be configured such that the user designates display details or a display position by performing a gesture of pointing a finger at a display position or designates sub-content by giving utterance expressing his/her wish to watch a certain type of sub-content.

### 6. Other Examples

A series of processes mentioned above can be executed by hardware and can also be executed by software. In a case in which the series of processing is executed by software, a program included in the software is installed in a dedicated hardware-incorporated computer, a general-purpose personal computer, or the like.

The program to be installed is provided recorded in the removable medium 111 illustrated in FIG. 3, the removable medium 111 including an optical disc (CD-ROM (Compact Disc-Read Only Memory), a DVD (Digital Versatile Disc), etc.), a semiconductor memory, or the like. In addition, it may be configured such that the program is provided via a wired or wireless transmission medium such as a local area network, the internet, or digital broadcasting. The program can be installed in advance in the ROM 102 or the storage unit 108.

Note that the program executed by a computer may be a program for which processes are performed in time series along an order explained in the present specification and may be a program for which processes are performed in parallel or at required timings such as when they are invoked.

Note that a system in the present specification means a set of a plurality of components (apparatuses, modules (parts), etc.), and it does not matter whether or not all the components are in a single housing. Accordingly, systems includes a plurality of apparatuses which are housed in separate housings and are connected to one another via a network, and one apparatus in which a plurality of modules are housed in one housing.

Note that the effects described in the present specification are merely illustrative and are not limited, and other effects may be obtained.

Embodiments of the present technique are not limited to the embodiments mentioned above, but various modifications can be made within the scope not deviating from the gist of the present technique.

For example, the present technique can have a cloud computing configuration in which a plurality of apparatuses share one function via a network, and perform processes in cooperation.

In addition, individual steps explained in the flowcharts mentioned above can be executed in one apparatus and can also be executed by a plurality of apparatuses in a sharing manner.

Furthermore, in a case in which one step includes a plurality of processes, the plurality of processes included in the one step can be executed by one apparatus and can also be executed by a plurality of apparatuses in a sharing manner.

### Combination Examples of Configurations

The present technique can also have the following configurations.

(1)

An information processing apparatus including:

an interest detecting unit detecting a matter of interest of a user regarding main content during reproduction of the main content; and

an output control unit controlling output of sub-content and an utterance sound regarding the sub-content on the basis of the matter of interest of the user.

(2)

The information processing apparatus according to (1), in which

the interest detecting unit detects the matter of interest of the user on the basis of at least any one of a line of sight, a posture, and utterance details of the user.

(3)

The information processing apparatus according to (1) or (2), in which

the interest detecting unit determines a degree of interest representing an extent of interest of the user in the matter of interest, and

in a case in which the degree of interest is higher than a predetermined reference, the output control unit outputs the sub-content regarding the matter of interest of the user, and the utterance sound.

(4)

The information processing apparatus according to any of (1) to (3), in which

the output control unit outputs the sub-content at a position in a sight of the user watching the main content.

(5)

The information processing apparatus according to (4), in which

the output control unit outputs the sub-content at a position which is different from a position of the main content and in the sight of the user watching the main content.

(6)

The information processing apparatus according to (4), in which

the output control unit outputs the sub-content at a position in the sight of the user watching the main content such that the sub-content partially overlaps the main content.

(7)

The information processing apparatus according to (6), in which

the output control unit outputs the sub-content such that a transparency of part of the sub-content that partially overlaps the main content is modified.

(8)

The information processing apparatus according to any of (3) to (7), in which

in a case in which the degree of interest in the sub-content becomes lower than the predetermined reference during the output of the sub-content or the utterance sound regarding the sub-content, the output control unit causes the output of the sub-content and the utterance sound to fade out.

(9)

The information processing apparatus according to (8), in which

in a case in which the degree of interest in the sub-content becomes higher than the predetermined reference from a start of the fade-out of the sub-content until an end of the fade-out, the output control unit outputs the sub-content and the utterance sound again.

(10)

The information processing apparatus according to (8), in which

in a case in which an instruction from the user to end the sub-content is detected from a start of the fade-out of the sub-content until an end of the fade-out, the output control unit stops the output of the sub-content and the utterance sound.

(11)

The information processing apparatus according to any of (3) to (7), in which

in a case in which the degree of interest in the sub-content becomes lower than the predetermined reference, the output control unit outputs alternative sub-content different from the sub-content and an utterance sound regarding the alternative sub-content instead of the sub-content.

(12)

The information processing apparatus according to (3), in which

when the degree of interest in the sub-content becomes higher than the degree of interest in the main content during the output of the sub-content or the utterance sound regarding the sub-content, the output control unit causes the output of the main content to fade out.

(13)

The information processing apparatus according to any of (3) to (12), in which

the output control unit outputs second sub-content and an utterance sound regarding the second sub-content, the second sub-content regarding a matter of interest in which the degree of interest is high, in the sub-content.

(14)

The information processing apparatus according to any of (3) to (13), in which

in a case in which the number of the users is plural, the output control unit controls the output of the sub-content and the utterance sound on the basis of degrees of interest of the users.

(15)

The information processing apparatus according to any of (3) to (13), in which

in a case in which the number of the users is plural, the output control unit controls the output of the sub-content and the utterance sound on the basis of the degree of interest of each of the users.

(16)

The information processing apparatus according to any of (3) to (15), in which

the output control unit outputs the sub-content with a position or a size of the sub-content being modified according to the degree of interest in the sub-content.

(17)

An information processing method including:

by an information processing apparatus,

detecting a matter of interest of a user regarding main content during reproduction of the main content; and

controlling output of sub-content and an utterance sound regarding the sub-content on the basis of the matter of interest of the user.

(18)

A program causing a computer to function as:

an interest detecting unit detecting a matter of interest of a user regarding main content during reproduction of the main content; and

an output control unit controlling output of sub-content and an utterance sound regarding the sub-content on the basis of the matter of interest of the user.

### REFERENCE SIGNS LIST

1 Content reproduction system, 11 Projector, 12 Screen, 21 Agent, 22 Main content, 23 Sub-content, 24 Line of sight, 51 Arithmetic operation apparatus, 52 Speaker, 53 Microphone, 54 Posture sensor, 55 Line-of-sight sensor, 56 Network, 151 Agent functioning unit, 152 Main-content reproduction unit, 153 Sub-content reproduction unit, 154 Output control unit, 161 State detecting unit, 162 Instruction detecting unit, 163 Interest detecting unit, 164 Main-content selecting unit, 165 Sub-content selecting unit, 166 Sub-content information acquiring unit, 167 Utterance unit

1. An information processing apparatus comprising:
an interest detecting unit detecting a matter of interest of a user regarding main content during reproduction of the main content; and
an output control unit controlling output of sub-content and an utterance sound regarding the sub-content on a basis of the matter of interest of the user.

2. The information processing apparatus according to claim 1, wherein
the interest detecting unit detects the matter of interest of the user on a basis of at least any one of a line of sight, a posture, and utterance details of the user.

3. The information processing apparatus according to claim 2, wherein
the interest detecting unit determines a degree of interest representing an extent of interest of the user in the matter of interest, and
in a case in which the degree of interest is higher than a predetermined reference, the output control unit outputs the sub-content regarding the matter of interest of the user, and the utterance sound.

4. The information processing apparatus according to claim 3, wherein
the output control unit outputs the sub-content at a position in a sight of the user watching the main content.

5. The information processing apparatus according to claim 4, wherein
the output control unit outputs the sub-content at a position which is different from a position of the main content and in the sight of the user watching the main content.

6. The information processing apparatus according to claim 4, wherein
the output control unit outputs the sub-content at a position in the sight of the user watching the main content such that the sub-content partially overlaps the main content.

7. The information processing apparatus according to claim 6, wherein
the output control unit outputs the sub-content such that a transparency of part of the sub-content that partially overlaps the main content is modified.

8. The information processing apparatus according to claim 3, wherein
in a case in which the degree of interest in the sub-content becomes lower than the predetermined reference during the output of the sub-content or the utterance sound regarding the sub-content, the output control unit causes the output of the sub-content and the utterance sound to fade out.

9. The information processing apparatus according to claim 8, wherein
in a case in which the degree of interest in the sub-content becomes higher than the predetermined reference from a start of the fade-out of the sub-content until an end of the fade-out, the output control unit outputs the sub-content and the utterance sound again.

10. The information processing apparatus according to claim 8, wherein
in a case in which an instruction from the user to end the sub-content is detected from a start of the fade-out of the sub-content until an end of the fade-out, the output control unit stops the output of the sub-content and the utterance sound.

11. The information processing apparatus according to claim 3, wherein
in a case in which the degree of interest in the sub-content becomes lower than the predetermined reference, the output control unit outputs alternative sub-content different from the sub-content and an utterance sound regarding the alternative sub-content instead of the sub-content.

12. The information processing apparatus according to claim 3, wherein
when the degree of interest in the sub-content becomes higher than the degree of interest in the main content during the output of the sub-content or the utterance sound regarding the sub-content, the output control unit causes the output of the main content to fade out.

13. The information processing apparatus according to claim 3, wherein
the output control unit outputs second sub-content and an utterance sound regarding the second sub-content, the second sub-content regarding a matter of interest in which the degree of interest is high, in the sub-content.

14. The information processing apparatus according to claim 3, wherein
in a case in which the number of the users is plural, the output control unit controls the output of the sub-content and the utterance sound on a basis of degrees of interest of the users.

15. The information processing apparatus according to claim 3, wherein
in a case in which the number of the users is plural, the output control unit controls the output of the sub-content and the utterance sound on a basis of the degree of interest of each of the users.

16. The information processing apparatus according to claim 3, wherein
the output control unit outputs the sub-content with a position or a size of the sub-content being modified according to the degree of interest in the sub-content.

17. An information processing method comprising:
by an information processing apparatus,
detecting a matter of interest of a user regarding main content during reproduction of the main content; and
controlling output of sub-content and an utterance sound regarding the sub-content on a basis of the matter of interest of the user.

18. A program causing a computer to function as:
an interest detecting unit detecting a matter of interest of a user regarding main content during reproduction of the main content; and
an output control unit controlling output of sub-content and an utterance sound regarding the sub-content on a basis of the matter of interest of the user.
